(19) United States
(12) Patent Application Publication
(10) Pub. No.: US 2022/0135209 A1
(43) Pub. Date: May 5, 2022

(54) AN ACTUATOR APPARATUS COMPRISING A POSITIONING ACTUATOR

(71) Applicant: SAAB AB, Linköping (SE)

(72) Inventor: Magnus LANDBERG, Linköping (SE)

(21) Appl. No.: 17/428,320

(22) PCT Filed: Feb. 5, 2019
(86) PCT No.: PCT/SE2019/050095

§ 371 Date: Aug. 4, 2021

(51) Int. Cl. B64C 13/40

(52) U.S. Cl. CPC B64C 13/40

(57) ABSTRACT

Provided is an actuator apparatus including a positioning actuator device configured to position a first carrier member of the actuator apparatus. The positioning actuator device includes a first hydraulic fluid actuator having a first clamping means and a second hydraulic fluid actuator having a second clamping means, wherein the first and second hydraulic fluid actuator are configured to alternately clamp around a guide arrangement for moving the positioning actuator device along the guide arrangement. The first carrier member is provided with a first coupling member configured to be releasable coupled to the positioning actuator device. A method of positioning a first carrier member by means of the positioning actuator device is provided.

### TECHNICAL FIELD

The present invention relates to an actuator apparatus. The present invention further relates to a method of positioning a first and a second carrier member by means of a positioning actuator device. The present invention also may relate to an aerial vehicle comprising the actuator apparatus or to a morphing wing, but is not limited to such applications. The present invention also may relate to a data medium storing program configured for controlling the actuator apparatus.

The present invention may concern the industry using actuator apparatus for different types of applications of positioning carrier members along a linear guide means or guide arrangement. The present invention may concern the industry producing actuator apparatuses. The present invention may concern the industry producing vehicles, such as aircraft.

### BACKGROUND

Current fluid actuator arrangements for positioning e.g. a respective tool or positioning device are dependent on a plurality of actuators, each moving e.g. a tool or a positioning device.

Arrangements for positioning e.g. tools or positioning devices may be designed for manual displacement of the tools or positioning devices along a linear bar or other guidance means.

Prior art arrangements are heavy and are energy consuming. They may be complex and not robust. Electromechanical actuators may also be used today to solve the problem of positioning of the tools or positioning devices. However, electromechanical actuators are heavy and energy consuming.

Manually moving the tools or positioning devices along the linear guidance means may involve ergonomic deficiency and poor safety and comfort for the user.

### SUMMARY OF THE INVENTION

There is an object to provide an actuator apparatus that is able to position e.g. tools or other positioning devices along a linear axis to selectable positions and to lock the tools or other positioning devices (carrier members) with high locking force.

There is an object to provide a simplified and/or robust actuator apparatus.

There is an object to provide an actuator apparatus that is configured to position a plurality of carrier members along a linear axis.

There is an object to provide cost-efficient production in manufacture industries and/or operation of different applications and in different technical fields.

There is an object to provide a robust actuator apparatus that is suitable to be used outdoors in harsh environment.

There is an object to improve ergonomic involving enhancing safety and comfort in positioning e.g. tools or other positioning devices along a linear axis.

There is an object to provide an energy saving and lightweight actuator apparatus.

There is an object to provide a compact actuator apparatus.

There is an object to provide an aircraft comprising a slender wing profile for reducing drag.

There is an object to provide a light-weight aircraft.

There is an object to provide a light-weight aircraft having a morphing wing comprising the actuator apparatus, which aircraft will have improved fuel or energy economy.

There is an object to provide redundancy for increasing reliability in operation of an actuator apparatus.

There is an object to provide an actuator apparatus that manages to handle high loads.

There is an object to provide an energy saving actuator apparatus that is configured to generate and distribute mechanical linear movement and force to e.g. morphing wing flexible skins.

There is an object to provide an energy saving actuator apparatus that is cost-effective to manufacture and in service maintenance.

There is an object to provide an actuator apparatus of a flight control system operating in several operational phases.

This or at least one of said objects has been solved by a method of positioning a first carrier member by means of a positioning actuator device, comprising a first hydraulic fluid actuator having a first clamping means and comprising a second hydraulic fluid actuator having a second clamping means, which are configured to alternately clamp around a guide arrangement for moving the positioning actuator device along the guide arrangement; the first carrier member is provided with a first coupling member configured to be releasable coupled to the positioning actuator device, and wherein the method comprises the steps of; couple the first carrier member and the positioning actuator device to each other; move the first carrier member by means of the positioning actuator device for positioning the first carrier member into a first position; lock the first carrier member and/or uncouple it from the positioning actuator device.

Alternatively, the positioning actuator device comprises a coupling element (coupling) that is configured to releasable couple a movable (and optionally lockable) adjustable device, such as an adjustable tool, an adjustable seat.

In such way is achieved that the positioning actuator device per se and one single carrier member may be used for positioning two separate movable (and optionally lockable) adjustable devices.

Alternatively, the method provides the positioning of the first and a second carrier member by means of the positioning actuator device, the first coupling member is configured to be releasable coupled to a second coupling member of the second carrier member; and the second carrier member is provided with a further coupling member configured to be releasable coupled to the positioning actuator device; the method comprises the steps of; couple the first carrier member, the second carrier member and the positioning actuator device to each other; move the first and the second carrier member by means of the positioning actuator device for positioning the first carrier member into the first position; lock the first carrier member and uncouple it from the second carrier member; move the second carrier member by means of the positioning actuator device for positioning the second carrier member into a second position; lock the second carrier member and uncouple it from the positioning actuator device.

Alternatively, the method comprises the further step; move a third carrier member by means of the positioning actuator device for positioning the third carrier member into a third position.

Alternatively, the method comprises the further steps; couple the first carrier member, the second carrier member and the positioning actuator device; move the first and the second carrier member by means of the positioning actuator device for positioning the first carrier member into a third position.

Alternatively, the method comprises the further steps; couple a sixth carrier member to a fifth carrier member; couple the fifth carrier member to a fourth carrier member; couple the fourth carrier member to a third carrier member; couple the third carrier member to the second carrier member; couple the second carrier member to the first carrier member; and couple the sixth carrier member to the positioning actuator device for moving the first carrier member.

Alternatively, the method comprises the further step; uncouple the first carrier member from the second carrier member and lock the first carrier member.

Alternatively, the method comprises the further step; uncouple the first carrier member from the second carrier member and lock the first carrier member to the guide arrangement.

At least the first carrier member is configured to be locked to the rod along which the positioning actuator device can be moved.

At least the first carrier member is configured to be locked to a guide (e.g. a guide rail) extending parallel with the rod along which the positioning actuator device can be moved.

The guide arrangement may comprises one common rod, along which the positioning actuator device and the at least one carrier member are moved and onto which they are locked.

The positioning actuator device may be configured with a scraper arrangement that keeps the envelope surface of the rod clean.

At least the first carrier member is configured to be locked to an external linear guide of the guide arrangement by means of an external lock or moved by the positioning actuator along the external linear guide, wherein the positioning actuator is moved along a parallel rod.

Alternatively, the method comprises the further step of; couple the first carrier member and the positioning actuator device to each other; move the first carrier member by means of the positioning actuator device for positioning the positioning actuator device into the first position.

This or at least one of said objects has been solved by an actuator apparatus comprising a positioning actuator device configured to position a first carrier member of the actuator apparatus; wherein the positioning actuator device comprises a first hydraulic fluid actuator having a first clamping means and a second hydraulic fluid actuator having a second clamping means, wherein the first and second hydraulic fluid actuator are configured to alternately clamp around a guide arrangement for moving the positioning actuator device along the guide arrangement; the first carrier member is provided with a first coupling member configured to be releasable coupled to the positioning actuator device.

Alternatively, the first carrier member may be called a single carrier member.

Alternatively, the positioning actuator device is configured to position a second carrier member of the actuator apparatus; the first coupling member is configured to be releasable coupled to a second coupling member of the second carrier member; and the second carrier member is configured to be releasable coupled to the positioning actuator device.

Alternatively, the first coupling member is configured to be releasable coupled to a first couple element of the positioning actuator device.

Alternatively, the second carrier member is configured to be releasable coupled to the positioning actuator device via a second coupling element.

Alternatively, the first carrier member is configured to be releasable coupled to the positioning actuator device via the second carrier member when the second carrier member is coupled to the positioning actuator device.

Alternatively, the first carrier member comprises a first clamping device and the second carrier member comprises a second clamping member.

Alternatively, the positioning actuator device is configured to position a plurality of carrier members.

Alternatively, an electrical control circuitry of the actuator apparatus is configured to control the method.

Alternatively, the actuator apparatus comprises a sensor device coupled to the electrical control circuitry and being configured to detect the position and/or motion rate of the positioning actuator device.

Alternatively, the sensor device comprises a position sensor, an end position sensor, a laser sensor or any other sensor device.

By detecting the positions of and taking into account (by the electrical control circuitry) each movement and operation step (e.g. coupling and uncoupling) performed by the positioning actuator device, the position of each carrier member can be determined.

Alternatively, a data medium storing program adapted for controlling the positioning of at least a first carrier member and a positioning actuator device of an actuator apparatus is provided; wherein the data medium storing program comprises a program code stored on a medium, which is readable on a computer, for causing the electrical control circuitry to perform the method steps of: couple the first carrier member, the second carrier member and the positioning actuator device; move the first and the second carrier member by means of the positioning actuator device for positioning the first carrier member into a first position; lock the first carrier member in position and uncouple it from the second carrier member; move the second carrier member by means of the positioning actuator device for positioning the second carrier member into a second position; lock the second carrier member in position and uncouple it from the positioning actuator device.

Alternatively, a data medium storing program product comprising a program code is stored on a medium, which is readable on a computer, for performing the method steps when said data medium storing program is run on the electrical control circuitry.

Alternatively, there is provided an aerial vehicle comprising the actuator apparatus.

Alternatively, there is provided a morphing wing of the aerial vehicle.

Alternatively, the positioning actuator device exhibits a first and a second end.

Alternatively, the positioning actuator device exhibits an intermediate portion formed between the first and the second end.

Alternatively, the first end of the positioning actuator device may be configured with a first coupling device.

Alternatively, the second end of the positioning actuator device may be configured with a second coupling device.

Alternatively, the intermediate portion of the positioning actuator device may be configured with an intermediate coupling device configured to couple a coupling arrangement of the carrier members one at the time.

Alternatively, the positioning actuator device is configured to be moved along the guide arrangement and at least one of the respective first and the second carrier member being configured to be moved parallel with the guide arrangement.

Alternatively, the at least one of the respective first and the second carrier member being configured to be moved by means of the positioning actuator device parallel with the guide arrangement along an elongated guide arrangement or other guide arrangement.

Alternatively, the second carrier member is provided with a second coupling member configured to be releasable coupled to the first carrier member.

Alternatively, the first carrier member exhibits a first end, a second end, and a first central portion there between.

Alternatively, the second carrier member exhibits a first end and a second end, and a second central portion there between.

Alternatively, a coupling interlock member is arranged at the second end of the first carrier member, the second end of which faces away from the positioning actuator device.

Alternatively, the first coupling member of the first carrier member is arranged at the first end of the first carrier member, wherein the first end of the first carrier member faces the second end of the positioning actuator device.

Alternatively, the first end of the first carrier member faces the second end of the positioning actuator device and faces the second end of the second carrier member.

Alternatively, the first coupling member of the first carrier member is arranged at the first end of the first carrier member.

Alternatively, the second coupling member of the second carrier member is configured to be able to be releasable coupled to or from the first coupling member of the first carrier member.

Alternatively, at least one of the first and second coupling member and/or coupling element comprises a mechanical and/or electro-mechanical and/or electro-magnetic coupling configured to couple the first and second coupling member to each other.

Alternatively, at least one of the first and second coupling member and/or coupling element is electrically coupled to an electrical control circuitry.

Alternatively, the electrical control circuitry is configured to control the coupling between the first coupling member (of the first carrier member) and the second coupling member (of the second carrier member).

Alternatively, the coupling member and/or coupling element may comprise a mechanical and/or electro-mechanical and/or electro-magnetic coupling and/or electro-pneumatic coupling and/or spring biased coupling and/or permanent magnetic coupling.

Alternatively, the first coupling member is configured to be coupled to the second coupling member automatically and/or semi-automatically and/or manually.

Alternatively, the first coupling member is configured to be coupled or released to/from the second coupling member automatically and/or semi-automatically by means of a first hydraulic logic valve connected to a branch of a hydraulic line connecting the first logic valve and the first clamping member of the first carrier member.

Alternatively, when pressurizing the first clamping member of the first carrier member, the first hydraulic logic valve is pressurized for releasing the first coupling member from the second coupling member.

Alternatively, the first hydraulic logic valve comprises a first spring for biasing a first actuator piston that is configured to couple and/or release the first coupling member to/from the second coupling member.

Alternatively, when the first hydraulic logic valve is pressurized, the spring biased first actuator piston presses the first spring for releasing the first coupling member from the second coupling member.

Alternatively, the first coupling member is configured to be coupled to the second coupling member by means of a separate control circuit or control unit.

Alternatively, a hydraulic accumulator reservoir is coupled to the fluid supply for providing an additional pressurized fluid source.

In such way there is provided that the clamping members and the clamping means will function in case of eventual drop in hydraulic pressure.

Alternatively, a check valve is arranged between the fluid supply and the hydraulic accumulator reservoir, which check valve is configured to hinder pressurized return fluid from the hydraulic accumulator reservoir to enter the fluid supply.

Alternatively, at least the first carrier member is configured to be locked to the rod along which the positioning actuator device moves.

Alternatively, at least the first carrier member is configured to be locked to a parallel (parallel with the rod) guide means (e.g. a guide rail) by means of a mechanical locking mechanism.

Alternatively, the mechanical locking mechanism is configured to be operated automatically and/or semi-automatically and/or manually.

Alternatively, the positioning actuator device comprises a lateral coupling element configured to be automatically, semi-automatically or manually coupled to a first lateral coupling member of the first carrier member.

Alternatively, the lateral coupling element is positioned laterally on the positioning actuator device.

Alternatively, the first lateral coupling member is positioned laterally on the first carrier member.

Alternatively, the positioning actuator device is configured to be coupled to a carrier member laterally or parallel positioned relative the rod.

Alternatively, the positioning actuator device is configured to be coupled to a first carrier member positioned laterally or parallel relative the rod.

Alternatively, the first carrier member is configured to be coupled to a second carrier member positioned laterally or parallel relative the rod.

In such way is achieved that also the positioning actuator device can be used for positioning a laterally positioned first carrier member.

Alternatively, the positioning actuator device comprises a first coupling device arranged at its first end, which first coupling device is configured to be releasable coupled to an interlock arrangement of the actuator apparatus, which interlock arrangement is configured to lock the positioning actuator device in locked position.

Alternatively, the positioning actuator device comprises a second coupling device arranged at the second end of the positioning actuator device, which second coupling device is configured to be releasable coupled to a first coupling member of the second carrier member.

Alternatively, the electrical control circuitry is configured to control the coupling between the first coupling member of the second carrier member and the positioning actuator device.

Alternatively, the electrical control circuitry is configured to control the coupling between the second coupling member of the second carrier member and the first coupling member of the first carrier member.

Alternatively, the positioning actuator device is configured to move the first and/or second carrier member along the guide arrangement.

Alternatively, the first hydraulic fluid cylinder actuator comprises a first cylinder encompassing a first piston comprising the first clamping means configured to clamp around the guide arrangement.

Alternatively, the second hydraulic fluid cylinder actuator comprises a second cylinder encompassing a second piston comprising the second clamping means configured to clamp around the guide arrangement.

Alternatively, the first piston is slidingly arranged in the first cylinder dividing its interior in a first and second cylinder chamber.

Alternatively, the second piston is slidingly arranged in the second cylinder dividing its interior in a third and fourth cylinder chamber.

Alternatively, the second hydraulic fluid actuator comprises a static holding body encompassing a second clamping means comprising a static clamping means configured to clamp around the guide arrangement.

Alternatively, the static clamping means comprises an expandable space coupled to a fluid supply via a logic valve or other suitable valve member.

Alternatively, the first carrier member comprises a first clamping member comprising a first expandable cavity configured to expand a first interior wall of the first clamping member towards the guide arrangement upon fluid pressurization of the first expandable cavity for locking the first carrier member in position with energy saving and high locking force.

Alternatively, the second carrier member comprises a second clamping member comprising a second expandable cavity configured to expand a second interior wall of the second clamping member towards the guide arrangement upon fluid pressurization of the second expandable cavity for locking the second carrier member in position with energy saving and high locking force.

Alternatively, the first expandable cavity is coupled to a fluid supply via a first logic valve device.

Alternatively, the second expandable cavity is coupled to a fluid supply via a second logic valve device.

Alternatively, the first clamping means of the first hydraulic fluid cylinder actuator is coupled to a fluid supply via a first valve member.

Alternatively, the first clamping means of the first hydraulic fluid cylinder actuator is coupled to a fluid supply via a first valve member.

Alternatively, the first cylinder chamber is coupled to the fluid supply via a first directional valve member.

Alternatively, the second cylinder chamber is coupled to the fluid supply via the first directional valve member.

Alternatively, the third cylinder chamber is coupled to the fluid supply via a second directional valve member.

Alternatively, the fourth cylinder chamber is coupled to the fluid supply via the second directional valve member.

Alternatively, the first and second hydraulic fluid actuator are controlled in motion by controlling the first directional valve member and the second directional valve member.

Alternatively, an electrical control circuitry is coupled to the first directional valve member for controlling the motion of the first hydraulic fluid actuator.

Alternatively, the electrical control circuitry is coupled to the second directional valve member for controlling the motion of the second hydraulic fluid actuator.

The directional valve member may be a 4/3 valve or other directional valve or a servo valve or other proportional valve.

Alternatively, the valve member and/or valve device may be operated mechanically, hydraulically, by solenoid control operations, or by a pneumatic fluid control system etc.

Alternatively, the first clamping means is controlled to clamp or release the first piston to or from the guide arrangement by controlling the first valve member.

Alternatively, the second clamping means is controlled to clamp or release the second piston to or from the guide arrangement by controlling the second valve member.

Alternatively, the electrical control circuitry is coupled to the first valve member for controlling the engagement of the first piston to the guide arrangement.

Alternatively, the electrical control circuitry is coupled to the second valve member for controlling the engagement of the second piston to the guide arrangement.

Alternatively, the fluid supply may be a hydraulic fluid supply that is common to all hydraulic fluid actuators and carrier members.

Alternatively, the fluid supply may comprise a set of individual fluid supplies, each coupled to the respective hydraulic fluid actuator and the respective carrier member.

Alternatively, the positioning actuator device is configured to push and/or pull at least one carrier members along the guide arrangement.

Alternatively, the aerial vehicle is a fixed wing aircraft comprising a morphing wing configuration providing shape-shifting airfoil properties and different aerodynamic performance.

Alternatively, a morphing wing of the fixed wing aircraft comprises a sub-structure interlinked with at least a first and a second carrier member of the actuator apparatus, which is encompassed in the morphing wing.

In such way is achieved that a light morphing wing also promoting smooth, quiet and efficient flight operated by a rigid actuator apparatus can be achieved.

Alternatively, the fixed wing aircraft is a UAV or other.

The guide arrangement may be called linear guidance means or guidance bar.

At least one of the carrier members may be configured to be locked in position on the guide arrangement by means of the clamping device, when pressurized.

A first and second carrier member (adjacent) may comprise a pressure controlled connection mechanism.

The pressure controlled connection mechanism may comprise a first logic valve means being associated with the first carrier member.

The first and second carrier member may be coupled to each other by said pressure controlled connection mechanism, which pressure controlled connection mechanism is configured to uncouple two adjacent carrier members from each other, when pressurized, and which pressure controlled connection mechanism is configured to couple two adjacent carrier members to each other, when not pressurized.

The first logic valve means associated with the first carrier member may be arranged between the logic valve device (controlling the clamping of the carrier member) and the pressure controlled connection mechanism.

The pressure fed to the first static clamping member of the first carrier member may be linked also to the first logic valve means for controlling (directly or indirectly) the pressure controlled connection mechanism.

The pressure fed to the first logic valve mean may influence the first logic valve means to control the pressure controlled connection mechanism to couple or uncouple the two adjacent carrier members to/from each other.

The uncoupling of the pressure controlled connection mechanism be provided at the same time as the second carrier member being unclamped from the guide arrangement.

The uncoupling of the pressure controlled connection mechanism between the first and second carrier member may be provided before or after that the second carrier member being unclamped from the guide arrangement.

The first coupling member of the first carrier member may be configured to be releasable coupled to the second coupling member of the second carrier member by means of a separate control unit, such as an electronic processor, e.g. controlling a separate logic valve, independently of whether the second carrier member being unclamped or not.

The first coupling member of the first carrier member may be configured to be releasable coupled to the second coupling member of the second carrier member by means of a joining mechanism that is directly influenced by the clamping action of the first and/or the second carrier member.

### BRIEF DESCRIPTION OF THE DRAWINGS

The present invention will now be described by way of examples with references to the accompanying schematic drawings, of which:

FIGS. 1a-1c illustrate an actuator apparatus according to a first example showing an exemplary principle of operation;

FIG. 1d illustrates an actuator apparatus according to a further example;

FIGS. 2a-2b illustrate a first carrier of an actuator apparatus according to a second example;

FIGS. 3a-3b illustrate a positioning actuator device of an actuator apparatus according to a third example;

FIG. 4 illustrates an actuator apparatus according to a fourth example;

FIGS. 5a-5b illustrate an aircraft comprising an actuator apparatus according to a fifth example;

FIGS. 6a-6c illustrate an actuator apparatus according to a sixth example showing an exemplary principle of operation;

FIG. 7 illustrates an actuator apparatus according to a seventh example;

FIGS. 8a-8c illustrate an actuator apparatus according to an eight example;

FIG. 9 illustrate an actuator apparatus according to a ninth example;

FIGS. 10a-10b illustrate an actuator apparatus according to a tenth example;

FIGS. 11-12 illustrate flowcharts showing exemplary methods according to different aspects of exemplary actuator apparatus; and

FIG. 13 illustrates a control unit of an exemplary actuator apparatus.

### DETAILED DESCRIPTION

Hereinafter, exemplary embodiments of the present invention will be described with reference to the accompanying drawings, wherein for the sake of clarity and understanding of the invention some details of no importance may be deleted from the drawings.

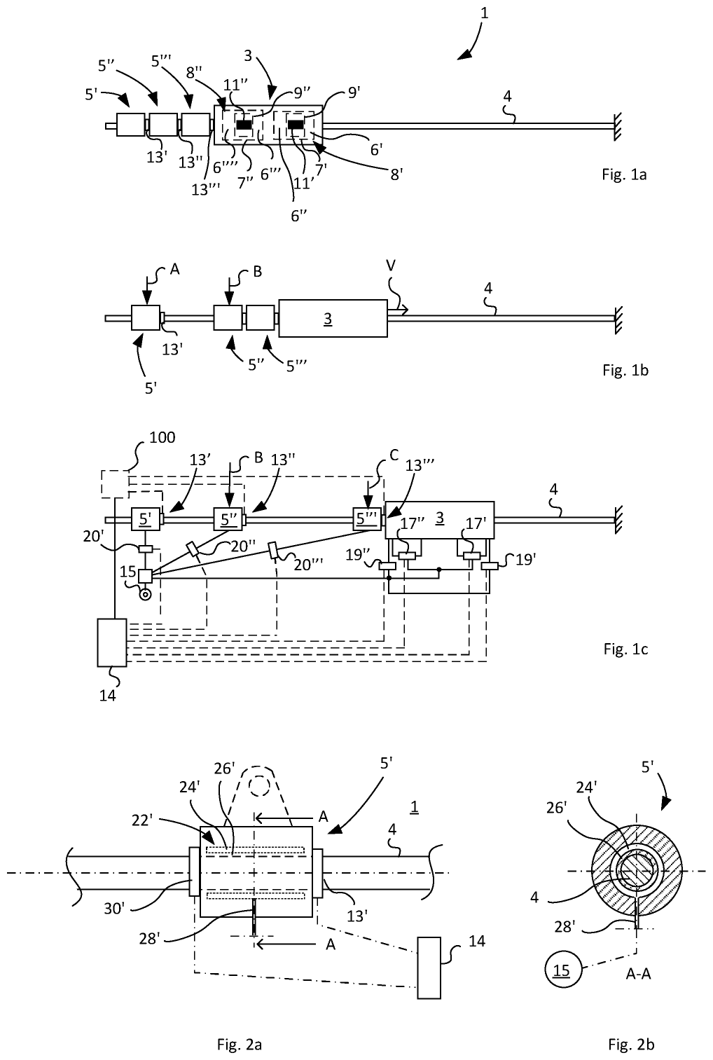

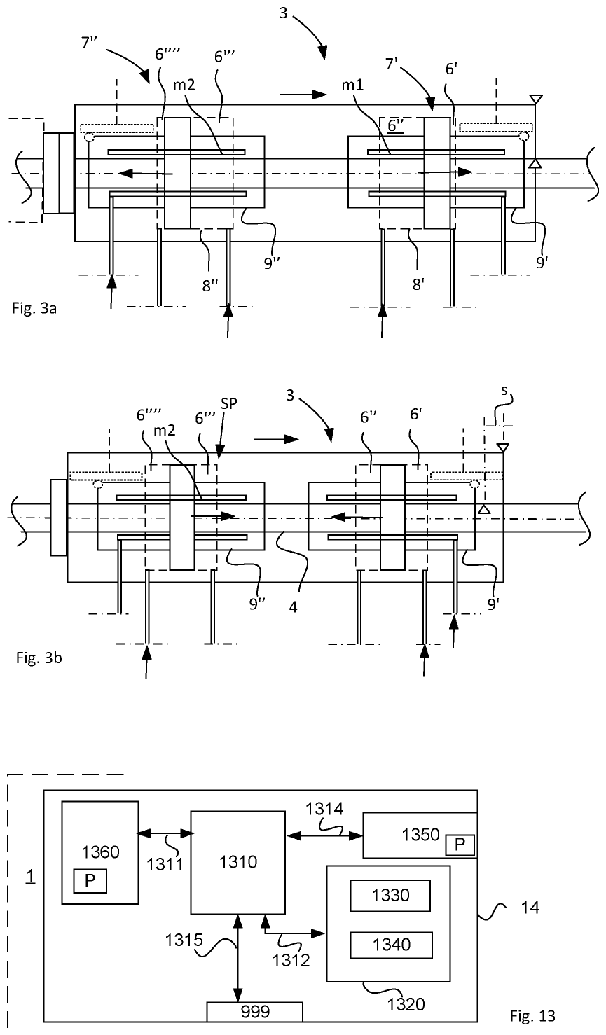

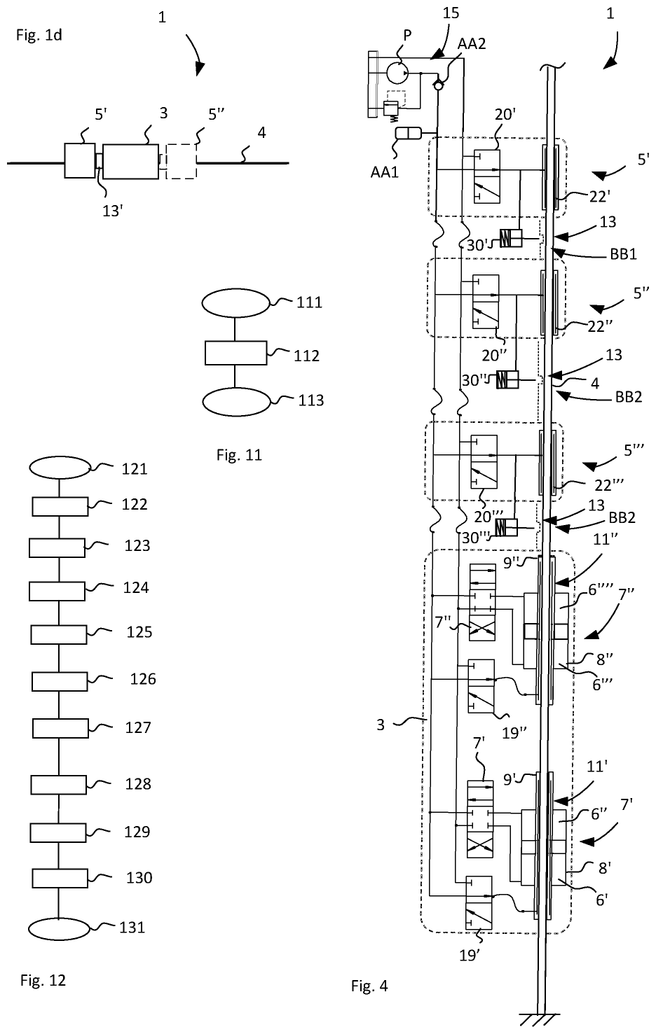

FIGS. 1a-1c illustrate an actuator apparatus 1 according to a first example showing an exemplary principle of operation. The actuator apparatus 1 shown in FIG. 1a comprises a positioning actuator 3 configured to position a first 5′, a second 5″ and a third carrier 5′″ along a rod 4. The respective carrier 5′, 5″, 5′″ may be coupled to or comprise a respective tool or linkage (not shown) or seat or other device.

The positioning actuator 3 comprises a first hydraulic fluid actuator 7′ having a first clamp 11′ of a first piston 9′ and a second hydraulic fluid actuator 7″ having a second clamp 11″ of a second piston 9″.

The first piston 9′ is slidingly arranged in a first cylinder housing 8′ dividing its interior in a first 6′ and second 6″ cylinder chamber.

The second piston 9″ is slidingly arranged in a second cylinder housing 8″ dividing its interior in a third 6′″ and fourth cylinder chamber 6″″.

For example, the first piston 9′ may be configured to clamp around the rod 4, whereas the second piston 9″ is unclamped from the rod 4, at the same time as the first cylinder chamber 6′ is pressurized for moving the positioning actuator 3 in accordance with arrow V in FIG. 1b.

For example, the second piston 9″ may be configured to clamp around the rod 4, whereas the first piston 9′ is unclamped from the rod 4, at the same time as the third cylinder chamber 6′″ is pressurized for moving the positioning actuator 3 further in accordance with arrow V in FIG. 1b.

The first and second clamp 11′, 11″ are configured to alternately clamp around the rod 4, along which the positioning actuator 3 moves, when pressurizing the respective cylinder chamber.

The first carrier 5′ is provided with a first coupling 13′ configured to be releasable coupled to a coupling (not shown) of the second carrier 5″.

The second carrier 5″ is provided with a second coupling 13″ configured to be releasable coupled to a coupling (not shown) of the third carrier 5″.

The third carrier 5′″ is provided with a third coupling 13′″ configured to be releasable coupled to a coupling (not shown) of the positioning actuator 3.

Each coupling may comprise a mechanical and/or electro-mechanical and/or electro-magnetic coupling.

In FIG. 1b is shown that the first carrier 5′ is released from the second carrier 5″ and locked into position A, whereas the positioning actuator 3 pulls the second 5″ and third 5′″ carrier further along the rod 4 until the second carrier 5″ is positioned in position B. The second carrier 5″ is released from the third carrier 5′″ and is locked in position B.

Subsequently, the third carrier 5′″ is pulled by the positioning actuator 3 further to position C as shown in FIG. 1c.

FIG. 1c also shows an arrangement of valves coupled to a fluid supply 15 and an electronic control circuitry 14 configured to control and move the positioning actuator 3 and couple/uncouple the carriers 5′, 5″, 5′″ to/from each other and to/from the positioning actuator 3.

The fluid supply 15 is coupled to the respective cylinder chamber of the positioning actuator 3 via directional valves 17′, 17″ for controlling hydraulic fluid communication between the fluid supply 15 and the respective cylinder chamber.

The directional valves 17′, 17″ are electrically coupled to the electronic control circuitry 14 configured to control the operation of the directional valves 17′, 17″ and control the motion rate and motion direction of the positioning actuator 3 along the rod 4.

The first 13′, the second 13″ and the third coupling 13′″ may be electrically coupled to the electronic control circuitry 14, which may be configured to control the coupling/uncoupling of the carriers 5′, 5″, 5′″ to or from each other and to or from the positioning actuator 3 via an electronic circuit 100.

The first carrier 5′ is configured to be releasable coupled to the positioning actuator 3 via the second carrier 5″ and the third carrier 5′″ as the second and third carrier are coupled to the positioning actuator 3.

Alternatively, two adjacent carriers may comprise and may be coupled to each other by a pressure controlled connection mechanism (not shown), which pressure controlled connection mechanism is configured to uncouple the two adjacent carriers from each other, when pressurized with a first pressure.

Alternatively, the first pressure also being used for clamping the carrier to the rod 4 by pressurizing a clamp of the carrier.

The first and the second clamp (shown in FIG. 1a as reference 11′, 11″) are configured to clamp around the rod 4 by pressurizing a respective first and second membrane (not shown) of the respective first and second piston 9′, 9″. The first clamp is coupled to the fluid supply 15 via a first logic valve 19′. The second clamp is coupled to the fluid supply 15 via a second logic valve 19″.

The respective logic valve 19′, 19″ being electrically coupled to the electronic control circuitry 14. The electronic control circuitry 14 is configured to control the respective first and second logic valve 19′, 19″ for clamping the respective piston around the rod 4.

A first logic regulator 20′ is coupled between the fluid supply 15 and a first clamping mechanism (e.g. reference 22′ shown in FIG. 2a) of the first carrier 5′. A second logic regulator 20″ is coupled between the fluid supply 15 and a second clamping mechanism (not shown) of the second carrier 5″. A third logic regulator 20′″ is coupled between the fluid supply 15 and a third clamping mechanism (not shown) of the third carrier 5″.

The respective clamping mechanism of the respective carrier may comprise an expandable cavity and an expandable interior wall (membrane), which is configured to clamp around the rod 4 upon hydraulic pressurization of the cavity for locking the carrier in position on the rod 4.

In such way there is achieved an energy efficient and robust locking of the carrier on the rod, without any energy losses.

The respective clamping mechanism of the respective carrier may be an external lock of the carrier (e.g. a passenger seat) configured to be moved along an external linear guide in parallel with the rod 4.

The electronic control circuitry 14 is electrically coupled to the respective first 20′, second 20″ and third logic regulator 20′″ for controlling the respective clamping mechanism to clamp or unclamp the rod 4.

FIG. 1d illustrates an actuator apparatus according to a further example. An actuator apparatus 1 comprises a positioning actuator 3 configured to position a first carrier 5′ (or may called single carrier) of the actuator apparatus 1. The positioning actuator device 3 comprises a first hydraulic fluid actuator (not shown) having a first clamping means and a second hydraulic fluid actuator (not shown) having a second clamping means.

The first and second hydraulic fluid actuator are configured to alternately clamp around a rod 4 for moving the positioning actuator 3 along the rod 4.

The first carrier 5′ is provided with a first coupling member 13′ configured to be releasable coupled to the positioning actuator device 3.

As an example, a second carrier 5″ may be placed on the other side of the positioning actuator 3 and configured to be coupled to the positioning actuator 3 via second releasable joint.

FIGS. 2a-2b illustrate a first carrier 5′ of an actuator apparatus 1 according to a second example. FIG. 2a shows from side a first clamping mechanism 22′ of the first carrier 5′ comprises a first expandable cavity 24′ configured to expand a first interior wall 26′ of the first clamping mechanism 22′ towards the rod 4 upon pressurization of the first expandable cavity 24′ by feeding fluid to the first expandable cavity 24′ via a first fluid line 28′ coupled between a fluid supply (reference 15 in FIG. 2b) and the first expandable cavity 24′.

Alternatively, the first expandable cavity 24′ is coupled to a fluid supply via a first valve unit, e.g. a first logic valve (not shown).

All the carriers of the actuator apparatus 1 may comprise this type of clamping mechanism for providing an energy efficient and robust locking of the respective positioned carrier.

Of course, any suitable clamping mechanism or lock may be used.

An electronic control circuitry 14 may be coupled to an interlock electro-mechanical coupling 30′ configured for locking the first carrier to a fundament (not shown) of the actuator apparatus 1.

A first electro-magnetic coupling 13′ may be electrically coupled to the electronic control circuitry 14 and configured to be coupled to a coupling (not shown) of a second carrier (not shown).

FIG. 2b shows the first carrier 5′ in cross section A-A. The first interior wall 26′ is arranged co-axially around the rod 4 and forms, co-axially with the rod 4, the first expandable cavity 24′ of the first carrier 5′.

FIGS. 3a-3b illustrate a positioning actuator 3 of an actuator apparatus according to a third example.

FIG. 3a shows the actuator apparatus 1 in a side view. The positioning actuator 3 comprises a first hydraulic fluid actuator 7′ having a first clamping membrane m1 of a first piston 9′ and a second hydraulic fluid actuator 7″ having a second clamping membrane m2 of a second piston 9″.

The first piston 9′ is slidingly arranged in a first cylinder housing 8′ dividing its interior in a first 6′ and second cylinder chamber 6″.

The second piston 9″ is slidingly arranged in a second cylinder housing 8″ dividing its interior in a third 6′″ and fourth cylinder chamber 6″″.

In FIG. 3b is shown that the positioning actuator 3 has moved the distance s.

The first piston 9′ clamps around the rod 4, whereas the second piston 9″ is released from the rod 4 by not pressurizing the second membrane m2, and the first cylinder chamber 6′ is pressurized for moving the positioning actuator 3 along the rod 4 relatively clamped first piston 9′.

The working stroke length of the may correspond with the distance s.

At the same time, the released second piston 9″ is returned to a starting position SP by pressurizing the fourth cylinder chamber 6″″ for subsequently move the positioning actuator 3a further second distance from the starting position SP corresponding with the working stroke length of the second piston 9″.

Accordingly, the second piston 9″ in a next step (not shown) clamps around the rod 4, whereas the first piston 9′ is unclamped from the rod 4 and returned for a new working stroke, at the same time as the third cylinder chamber 6′″ is pressurized for moving the positioning actuator 3 the second distance (not shown).

The first and second clamp 11′, 11″ are configured to alternately clamp around the rod 4, along which the positioning actuator 3 moves, when pressurizing the respective cylinder chamber.

The movement of the positioning actuator 3 along the rod 4 is controlled by a CPU (central processor unit) and the positioning actuator 3 may be configured to move backward and forward and may be parked in locked position.

Alternatively, absolute positions and/or continuous movements (or incremental motions) of the positioning actuator 3 is detected by a sensor device.

The sensor device may comprise a position sensor, an end position sensor, a laser sensor and/or other sensors.

The second hydraulic fluid actuator 7″ comprising the second clamping membrane m2 of the second piston 9″ may be replaced by a static clamping mechanism (static clamping unit).

The static clamping mechanism may be designed with a similar clamping functionality and having the same features as the first carrier 5′ shown in FIG. 2a.

The static clamping mechanism of the positioning actuator 3 cooperates with the first hydraulic fluid actuator 7′ for moving the positioning actuator 3 along the rod 4 intermittently.

FIG. 4 illustrates an actuator apparatus 1 according to a fourth example and an exemplary first configuration of hydraulic valves coupled between a fluid supply 15 and a first 5′, a second 5″ and a third 5′″ carrier arranged around a rod 4. An exemplary second configuration of hydraulic valves is further coupled between the fluid supply 15 and a positioning actuator 3 arranged around and movable along the rod 4.

The first 5′, second 5″ and third 5′″ carrier are movable individually or together along the rod 4. A respective coupling 13 is arranged between the respective first 5′, second 5″ and third 5′″ carrier and between the third 5′″ carrier and the positioning actuator 3. The positioning actuator 3 is configured to be releasable coupled to the third carrier 5′″ and pull the “train” of carriers along the rod 4. The actuator apparatus 1 is configured to uncouple the first carrier 5′ at any suitable position and lock the first carrier 5′ on the rod 4.

The positioning actuator 3 comprises a first hydraulic fluid actuator 7′ having a first clamp 11′ of a first piston 9′ and a second hydraulic fluid actuator 7″ having a second clamp 11″ of a second piston 9″.

The first piston 9′ is slidingly arranged in a first cylinder housing 8′ dividing its interior in a first 6′ and second 6″ cylinder chamber.

The second piston 9″ is slidingly arranged in a second cylinder housing 8″ dividing its interior in a third 6′″ and fourth 6″″ cylinder chamber.

The first and second clamp 11′, 11″ are configured to alternately clamp around the rod 4 and the respective cylinder chamber is individually pressurized in a certain order for moving the positioning actuator 3 along the rod 4.

The fluid supply 15 is coupled to the respective cylinder chamber via a first and second directional valve 17′, 17″ for controlling hydraulic fluid communication between the fluid supply 15 and the respective cylinder chamber for moving the positioning actuator 3 along the rod 4.

The first clamp 11′ is coupled to the fluid supply 15 via a first logic valve 19′. The second clamp 11″ is coupled to the fluid supply 15 via a second logic valve 19″.

A first logic valve 20′ is coupled between the fluid supply 15 and a first clamping mechanism 22′ of the first carrier 5′. A second logic valve 20″ is coupled between the fluid supply 15 and a second clamping mechanism 22″ of the second carrier 5″. A third logic valve 20′″ is coupled between the fluid supply 15 and a third clamping mechanism 22′″ of the third carrier 5′″.

A hydraulic accumulator reservoir AA1 of the fluid supply 15 may be coupled to the respective first, second and third logic valve 20′, 20″, 20″. The hydraulic accumulator reservoir AA1 is pressurized and recharged by the fluid supply 15 providing that the clamping functionality of the actuator apparatus 1 is guaranteed even if the hydraulic pressure generated by a fluid supply pump P of the fluid supply 15 drops.

A check valve AA2 may be arranged between the fluid supply 15 and the hydraulic accumulator reservoir AA1, which check valve AA2 is configured to hinder pressurized fluid from the hydraulic accumulator reservoir AA1 to enter the pump P.

The first 5′ and second 5″ carrier may comprise a pressure controlled connection mechanism BB1.

The pressure controlled connection mechanism BB1 may comprise a first logic control valve 30′ being associated with the first carrier 5′.

A pressure controlled connection mechanism BB2 may comprise a second logic control valve 30″ being associated with the second carrier 5″.

A pressure controlled connection mechanism BB3 may comprise a third logic control valve 30′″ being associated with the third carrier 5″.

The first 5′ and second 5″ carrier may be coupled to each other by said pressure controlled connection mechanism BB1, which pressure controlled connection mechanism BB1 is configured to uncouple the carriers 5′, 5″ from each other, when pressurized, and which pressure controlled connection mechanism BB1 is configured to couple the carriers 5′, 5″ to each other, when not pressurized.

The first logic control valve 30′ may be arranged between the first logic valve 20′ (controlling the clamping of the first carrier 5′) and the pressure controlled connection mechanism BB1.

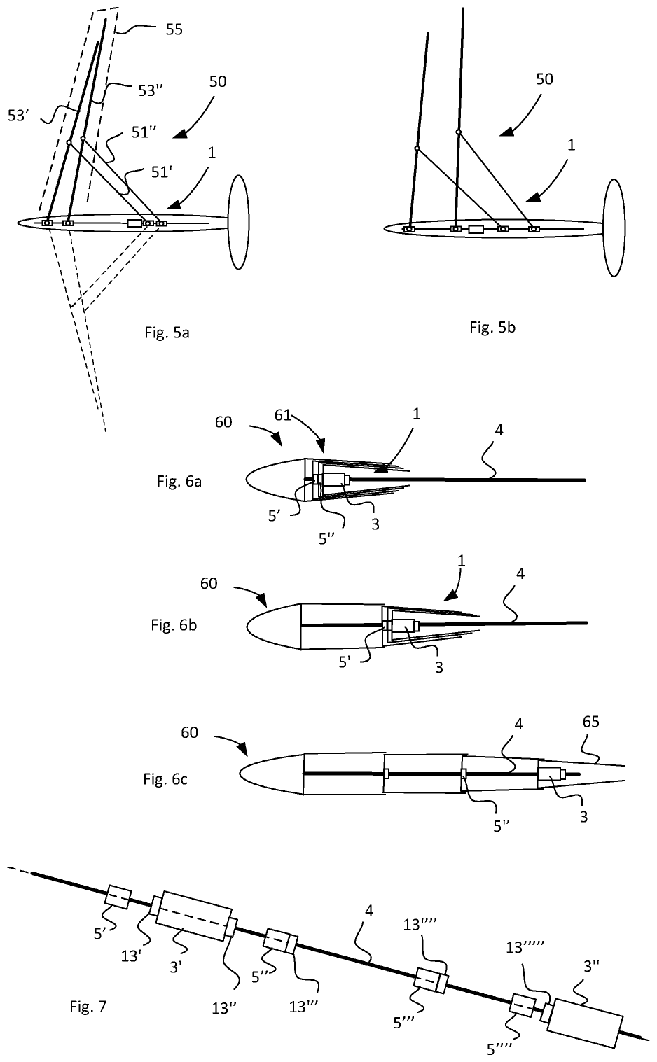

FIG. 5a schematically illustrates an aircraft 50 comprising an actuator apparatus 1 according to a fifth example. The actuator apparatus 1 is coupled to a first and second push rod 51′, 51″ for operating a respective front and rear spar 53′, 53″ of a morphing wing 55 or variable sweep wing. FIG. 5a schematically illustrates a positioning sequence performed by the actuator apparatus 1. FIG. 5b schematically shows that the wing chord (only one wing is shown) is increased and that the wing is swept forwardly by means of the actuator apparatus 1.

FIGS. 6a-6c illustrate an actuator apparatus 1 according to a sixth example showing an exemplary principle of operation of a retraction/extension mechanism 61 coupled to the actuator apparatus 1. The retraction/extension mechanism 61 is arranged in an airfoil 60 configured for high speed flight mode and low speed flight mode. The actuator apparatus 1 comprises a positioning actuator 3 configured to position a first 5′ and a second carrier 5″ along a rod 4. FIG. 6a shows the airfoil 60 in fully retracted state for low speed flight mode. In FIG. 6b is shown that the positioning actuator 3 has moved the first carrier 5′ to a first locked position at which the airfoil 60 is in a semi-extended state. In FIG. 6c is shown that the positioning actuator 3 has further moved the second carrier 5″ to a second position and that the positioning actuator 3 coupled to a trailing edge skin 65 has moved further to a third position at which the airfoil 60 is fully extended.

FIG. 7 illustrates an actuator apparatus 1 according to a seventh example. The actuator apparatus 1 comprises a first and a second positioning actuator 3′, 3″ movable along and configured to be releasable and lockable from/to a common rod 4. A first carrier 5′ is configured to be releasable coupled to the first positioning actuator 3′ via a first coupler 13′. A second carrier 5″ is configured to be releasable coupled to the first positioning actuator 3′ via a second coupler 13″. A third carrier 5′″ is configured to be releasable coupled to the second carrier 5″ via a third coupler 13″. A fourth carrier 5″″ is configured to be releasable coupled to the third carrier 5′″ via a fourth coupler 13″″ and is configured to be releasable coupled to a second positioning actuator 3″ via a fifth coupler 13″″. The second positioning actuator 3″ may be used to position the carriers and may be parked in a parking position and used as spare positioning actuator.

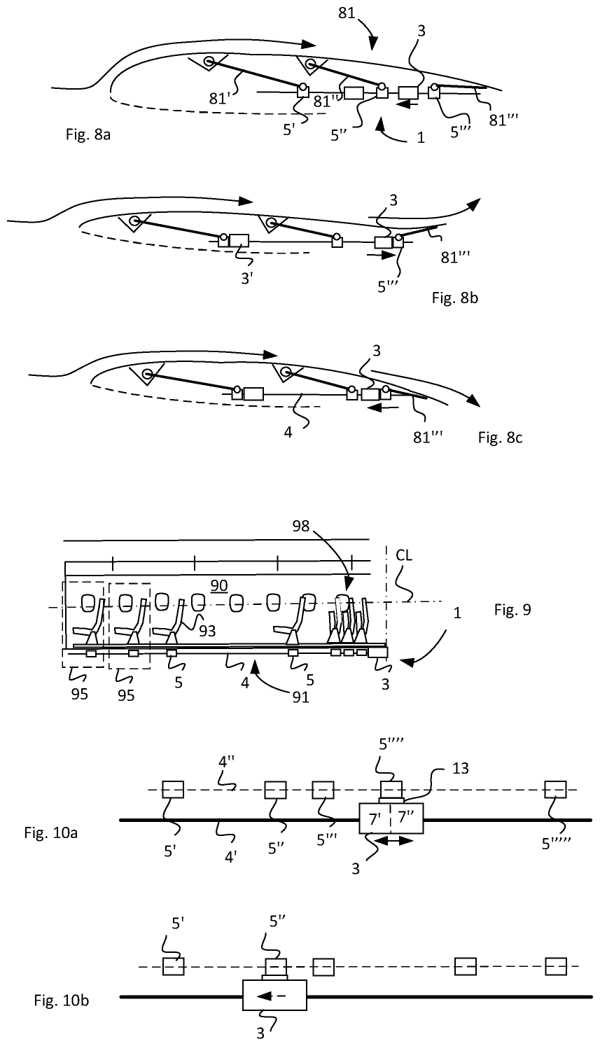

FIGS. 8a-8c illustrate an actuator apparatus 1 according to an eight example. FIG. 8a shows in cross-section and in a side view a morphing wing 81 of an aircraft. The actuator apparatus 1 comprises a first carrier 5′, a second carrier 5″ and a third carrier 5′″ and a rear positioning actuator 3. The respective carrier is coupled to a first 83′, second 83″ and third 83′″ push rod for changing the shape of the morphing wing 81. In FIG. 8a is shown that the rear positioning actuator 3 has been uncoupled from the third carrier 5′″, which is in locked neutral position, and moves toward the second carrier 5″ for repositioning. At the same time, as shown in FIG. 8b, a front positioning actuator 3′ is coupled to the first carrier 5′, which is moved to a front position, whereby the wing cord is reshaped to thin airfoil shape and more flat camber line. The rear positioning actuator 3 is coupled to the third carrier 5′″ and moves the third 83′″ push rod making the trailing edge of the wing to bend upward. In FIG. 8s is shown that the rear positioning actuator 3 is moved forward along the rod 4 for operating the third push rod 83′″ to bend the trailing edge of the wing downward.

FIG. 9 illustrates an actuator apparatus 1 according to a ninth example. Seats 93 are arranged in an airline cabin 90, which may be a narrow-body cabin or wide-body cabin. The actuator apparatus 1 is arranged in a sub-structure 91 of the airline cabin 90. The seats 93 may be arranged side-by-side in blocks 95, which in turn are arranged in a row along the airline cabin 90 prolongation and parallel with the centre line CL of the aircraft. Each block 95 is coupled to a respective carrier 5 of the actuator apparatus 1. A positioning actuator 3 of the actuator apparatus 1 is arranged on a guiding rod 4 and is configured for positioning the respective carrier 5 on the rod 4. Airlines usually want the flexibility to move seats around or remove them. The blocks 95 are coupled to the carriers 5 and for reconfiguration of the seating, the blocks 95 are released from the guiding rod 4 and moved along the guiding rod 4 by means of the positioning actuator 3 to a storage position 98. For example, aircraft cabin cleaning stuff or service and maintenance personnel thus will have full access to the interior of the airline cabin 90.

FIGS. 10a-10b illustrate an actuator apparatus according to a tenth example. FIG. 10a shows an actuator apparatus 1 comprising a positioning actuator 3 configured to position a first 5′, a second 5″, a third 5′″, a fourth 5′″ and a fifth 5′″ carrier of the actuator apparatus 1. The positioning actuator 3 comprises a first hydraulic fluid actuator 7′ having a first clamp mechanism (not shown) and a second hydraulic fluid actuator 7″ having a second clamp mechanism (not shown).

The second hydraulic fluid actuator 7″ may comprise a static holding body encompassing a second clamp comprising a static clamp configured to clamp around the guide arrangement.

The first and second hydraulic fluid actuator 7′, 7″ are configured to alternately clamp around a first rod 4′ for moving the positioning actuator 3 along the first rod 4′. The first 5′, second 5″, third 5′″, fourth 5′″ and fifth 5′″ carrier are arranged slidingly arranged and moved along a second rod 4″ and are lockable at optional positions on the second rod 4″. The positioning actuator 3 is arranged with a coupling 13 that is configured to couple the respective carrier to the positioning actuator 3 for individually moving the respective carrier along the second rod 4″. The coupling 13 is arranged laterally to the positioning actuator 3. A respective coupling mechanism is arranged to each carrier. Each coupling mechanism (not shown) is arranged laterally to the respective carrier and is configured to be able to couple the coupling 13.

Alternatively, the first carrier 5′ may also be provided with a first coupling (not shown) configured to be releasable coupled to a second coupling of the second carrier and the second carrier may be provided with a coupling configured to be releasable coupled to the positioning actuator 1.

The coupling 13 may comprise a lateral coupling element configured to be automatically, semi-automatically or manually coupled to a lateral coupling member of the respective carrier.

The lateral coupling element may be positioned laterally on the positioning actuator 3.

The lateral coupling member may be positioned laterally on each carrier 5′, 5″, 5′″, 5″″.

By providing an actuator apparatus 1 comprising a positioning actuator 3 configured to be coupled to carriers arranged on an external guide rail or second rod 4″, the actuator apparatus 1 is compatible with existing guide rails and carrier like arrangements, such as airline seats.

FIG. 10a shows that the positioning actuator 3 has moved to the second carrier 5″ for repositioning the second carrier 5″, alternatively together with the first carrier 5′.

FIGS. 11-12 illustrate flowcharts showing exemplary methods according to different aspects of exemplary actuator apparatus. An electrical control circuitry of the actuator apparatus is configured to control the method steps.

FIG. 11 shows an exemplary method of positioning a first carrier member by means of a positioning actuator device, comprising a first hydraulic fluid actuator having a first clamping means and comprising a second hydraulic fluid actuator having a second clamping means, which are configured to alternately clamp around a guide arrangement for moving the positioning actuator device along the guide arrangement; the first carrier member is provided with a first coupling member configured to be releasable coupled to the positioning actuator device.

One aspect may regard the positioning of a first and a second carrier member by means of a positioning actuator device, comprising a first hydraulic fluid actuator having a first clamping means and comprising a second hydraulic fluid actuator having a second clamping means, which are configured to alternately clamp around a guide arrangement for moving the positioning actuator device along the guide arrangement; the first carrier member is provided with a first coupling member configured to be releasable coupled to a second coupling member of the second carrier member; the second carrier member is provided with a first coupling member configured to be releasable coupled to the positioning actuator device.

The method comprises a first step 111 starting the method. A second step 112 presents the performance of the method. A third step 113 comprises stopping the method.

The second step 112 may comprise the sequences; couple the first carrier member and the positioning actuator device to each other; move the first carrier member by means of the positioning actuator device for positioning the first carrier member into a first position; lock the first carrier member and/or uncouple it from the positioning actuator device.

According to a further aspect, the second step may comprise the sequences; couple the first carrier member, the second carrier member and the positioning actuator device to each other; move the first and the second carrier member by means of the positioning actuator device for positioning the first carrier member into a first position; lock the first carrier member in position and uncouple it from the second carrier member; move the second carrier member by means of the positioning actuator device for positioning the second carrier member into a second position; lock the second carrier member in position and uncouple it from the positioning actuator device.

FIG. 12 shows an exemplary method of positioning a first and a second carrier member by means of a positioning actuator device. The method comprises a first step 121 starting the method. A second step 122 comprises; couple the first carrier member, the second carrier member and the positioning actuator device to each other. A third step 123 comprises; move the first and the second carrier member by means of the positioning actuator device for positioning the first carrier member into a first position. A fourth step 124 comprises; lock the first carrier member in position and uncouple it from the second carrier member. A fifth step 125 comprises; move the second carrier member by means of the positioning actuator device for positioning the second carrier member into a second position. A sixth step 126 comprises; lock the second carrier member in position and uncouple it from the positioning actuator device. A seventh step 127 comprises; move a third carrier member by means of the positioning actuator device for positioning the third carrier member into a third position. An eight step 128 comprises; couple the first carrier member, the second carrier member and the positioning actuator device to each other. A ninth step 129 comprises move the first and the second carrier member by means of the positioning actuator device for positioning the first carrier member into a third position. A tenth step 130 comprises; uncouple the positioning actuator device from the second carrier member. An eleventh step 131 comprises stopping the method.

The method may comprise the steps of; move the positioning actuator device in parallel with and into position beside the first carrier member; couple the positioning actuator device to the first carrier member; uncouple the positioning actuator device from the first carrier member; move the positioning actuator device in parallel with and into position beside a third carrier member; couple the positioning actuator device to the third carrier member.

FIG. 13 illustrates an electrical control circuitry 14 of an exemplary actuator apparatus 1. The electrical control circuitry 14 is configured to position a first and a second carrier member by means of a positioning actuator device of the actuator apparatus 1.

The electrical control circuitry 14 comprises a computer. The electrical control circuitry 14 comprises a non-volatile memory NVM 1320, which is a computer memory that can retain stored information even when the computer is not powered.

The electrical control circuitry 14 further comprises a processing unit 1310 and a read/write memory 1350. The NVM 1320 comprises a first memory unit 1330. A computer program (which can be of any type suitable for any operational data) is stored in the first memory unit 1330 for controlling the operation of the electrical control circuitry 14. Furthermore, the electrical control circuitry 14 comprises a bus controller (not shown), a serial communication left (not shown) providing a physical interface, through which information transfers separately in two directions.

The electrical control circuitry 14 may comprise any suitable type of I/O module (not shown) providing input/output signal transfer, an A/D converter (not shown) for converting continuously varying signals from detectors (not shown) of the actuator apparatus 1 and from other monitoring units (not shown) for detecting the positions of each carrier member and/or guide arrangement and/or the piston (s), into binary code suitable for the computer.

Other operational data may be actual loads, position actuator velocity, etc.

The electrical control circuitry 14 also comprises an input/output unit (not shown) for adaptation to time and date. The electrical control circuitry 14 comprises an event counter (not shown) for counting the number of event multiples that occur from independent events in operation of the actuator apparatus 1.

Furthermore, the electrical control circuitry 14 includes interrupt units (not shown) associated with the computer for providing a multi-tasking performance and real time computing for automatically adapting the speed of the first, second, third piston rods and other features in accordance with programed data.

The NVM 1320 also includes a second memory unit 1340 for external controlled operation. A data medium storing program P may comprise routines for automatically adapting the speed of the positioning actuator device and for operating the electrical control circuitry 14 for performing the method.

The data medium storing program P comprises a program code stored on a medium, which is readable on the computer, for causing the electrical control circuitry 14 to perform the method.

The data medium storing program P further may be stored in a separate memory 1360 and/or in the read/write memory 1350. The data medium storing program P, in this embodiment, is stored in executable or compressed data format.

It is to be understood that when the processing unit 1310 is described to execute a specific function that involves that the processing unit 1310 may execute a certain part of the program stored in the separate memory 1360 or a certain part of the program stored in the read/write memory 1350.

The processing unit 1310 is associated with a data port 999 for communication via a first data bus 1315. The non-volatile memory NVM 1320 is adapted for communication with the processing unit 1310 via a second data bus 1312. The separate memory 1360 is adapted for communication with the processing unit 1310 via a third data bus 1311. The read/write memory 1350 is adapted to communicate with the processing unit 1310 via a fourth data bus 1314. The data port 999 is preferably connectable to data links of the apparatus. When data is received by the data port 999, the data will be stored temporary in the second memory unit 1340.

After that the received data is temporary stored, the processing unit 1310 will be ready to execute the program code, according to the above-mentioned method.

Preferably, the signals (received by the data port 999) comprise information about operational status of the actuator apparatus 1, such as operational status regarding the position of the respective first, second and third carrier member and the position of the positioning actuator device.

The signals may also comprise information about e.g. operational data regarding fluid pressure data and/or load data and/or fluid temperature, etc.

According to one aspect, signals received by the data port 999 may contain information about actual positions of the pistons relative the cylinder housings by means of sensor devices. The received signals at the data port 999 can be used by the electrical control circuitry 14 for controlling and monitoring automatically adaptation of the speed and/or motion and/or position of the pistons in accordance with predetermined values.

The signals received by the data port 999 can be used for automatically moving the piston between two end positions, i.e. between two cylinder heads of the cylinder housing.

The signals can be used for different operations of the fluid actuator arrangement, such as operating the pressurization of each individual clamping means and/or clamping device. The information is preferably measured by means of suitable sensor devices of the apparatus.

The information can be manually fed to the electrical control circuitry 14 via a suitable communication device, such as a computer display or a touchscreen.

The method can also partially be executed by the electrical control circuitry 14 by means of the processing unit 1310, which processing unit 1310 runs the data medium storing program P being stored in the separate memory 1360 or the read/write memory 1350. When the electrical control circuitry 14 runs the data medium storing program P, suitable method steps disclosed herein will be executed.

Alternatively, a first sensor device measures the position of the first piston relative the first cylinder housing and feeds a first piston body position data to the electrical control circuitry 14.

The electrical control circuitry 14 registers the history of engagements of the first piston to the rod.

Alternatively, a second sensor device measures the position of the second piston relative the second cylinder housing and feeds a second piston body position data to the electrical control circuitry 14.

The electrical control circuitry 14 registers the history of engagements of the second piston to the rod.

Each clamping and motion thus being related to and taken into account for each measured data regarding the position of the first and second piston by means of the electrical control circuitry 14.

The present invention is of course not in any way restricted to the examples described above, but many possibilities to modifications, or combinations of the described examples thereof should be apparent to a person with ordinary skill in the art without departing from the basic idea of the invention as defined in the appended claims.

1. A method of positioning a first carrier member and a second carrier member by means of a positioning actuator device, comprising:
a first hydraulic fluid actuator having a first clamping means and comprising a second hydraulic fluid actuator having a second clamping means, which are configured to alternately clamp around a guide arrangement for moving the positioning actuator device along the guide arrangement;
the first hydraulic fluid actuator comprises a first cylinder encompassing a first piston comprising the first clamping means configured to clamp around the guide arrangement;
the second hydraulic fluid actuator comprises a second cylinder encompassing a second piston comprising the second clamping means configured to clamp around the guide arrangement;
wherein the first piston is slidingly arranged in the first cylinder dividing its interior in a first and second cylinder chamber; the second piston is slidingly arranged in the second cylinder dividing its interior in a third and fourth cylinder chamber;
the first carrier member is provided with a first coupling member configured to be releasable coupled to the positioning actuator device;
the method comprises the steps:
couple the first carrier member and the positioning actuator device to each other;
move the first carrier member by means of the positioning actuator device for positioning the first carrier member into a first position;
lock the first carrier member and/or uncouple it from the positioning actuator device, wherein the first coupling member is configured to be releasable coupled to a second coupling member of the second carrier member;
the method comprising the further steps:
couple the first carrier member, the second carrier member and the positioning actuator device to each other;
move the first and the second carrier member by means of the positioning actuator device for positioning the first carrier member into the first position;
lock the first carrier member and uncouple it from the second carrier member;
move the second carrier member by means of the positioning actuator device for positioning the second carrier member into a second position; and
lock the second carrier member and uncouple it from the positioning actuator device.

2. (canceled)

3. The method according to claim 1, wherein the method comprises the further step:
move a third carrier member by means of the positioning actuator device for positioning the third carrier member into a third position.

4. The method according to claim 1, wherein the method comprises the further step:
couple the first carrier member and the positioning actuator device to each other;
move the first carrier member by means of the positioning actuator device for positioning the positioning actuator device into the first position.

5. The method according to claim 1, wherein the method comprises the further step:
couple a sixth carrier member to a fifth carrier member;
couple the fifth carrier member to a fourth carrier member;
couple the fourth carrier member to a third carrier member;
couple the third carrier member to a second carrier member;
couple the second carrier member to the first carrier member; and
couple the sixth carrier member to the positioning actuator device for moving the first carrier member into the first position.

6. An actuator apparatus comprising:
a positioning actuator device configured to position a first carrier member and a second carrier member of the actuator apparatus;
wherein the positioning actuator device comprises a first hydraulic fluid actuator having a first clamping means and a second hydraulic fluid actuator having a second clamping means, wherein the first and second hydraulic fluid actuator are configured to alternately clamp around a guide arrangement for moving the positioning actuator device along the guide arrangement;
wherein the first carrier member is provided with a first coupling member configured to be releasable coupled to the positioning actuator device,
the first hydraulic fluid actuator comprises a first cylinder encompassing a first piston comprising the first clamping means configured to clamp around the guide arrangement;
the second hydraulic fluid actuator comprises a second cylinder encompassing a second piston comprising the second clamping means configured to clamp around the guide arrangement;
wherein the first piston is slidingly arranged in the first cylinder dividing its interior in a first and second cylinder chamber;
the second piston is slidingly arranged in the second cylinder dividing its interior in a third and fourth cylinder chamber;
wherein the first coupling member is configured to be releasable coupled to a second coupling member of the second carrier member; and
the second carrier member is configured to be releasable coupled to the positioning actuator device.

7. (canceled)

8. The actuator apparatus according to claim 6, wherein the first carrier member comprises a first clamping device.

9. The actuator apparatus according to claim 6, wherein the positioning actuator device is configured to position a plurality of carrier members.

10. The actuator apparatus according to claim 6, wherein an electrical control circuitry of the actuator apparatus is configured to control the method according to claim 1.

11. A data medium storing program configured to control the positioning of a first carrier member and a positioning actuator device of an actuator apparatus according to claim 10, wherein the data medium storing program comprises a program code stored on a medium, which is readable on a computer, for causing the electrical control circuitry to perform the method steps according to claim 1.

12. A data medium storing program product comprising a program code stored on a medium, which is readable on a computer, for performing the method steps according to claim 1, when a data medium storing program according to claim 11 is run on the electrical control circuitry.

13. An aerial vehicle comprising the actuator apparatus according to claim 6.

14. A morphing wing of the aerial vehicle according to claim 13.
